(19) United States
(12) Patent Application Publication
(10) Pub. No.: US 2002/0046939 A1
(43) Pub. Date: Apr. 25, 2002

(54) Electrical switch combined with an electrical product

(76) Inventors: Yi-Chi Lee, Taipei Hsien (TW); Chein-Cheng Liu, Taipei Hsien (TW)

Correspondence Address: J.C. PATENTS INC., 4 Venture, Suite 250, Irvine, CA, 92618, US

(21) Appl. No.: 09/761,874

(22) Filed: Jan. 17, 2001

(30) Foreign Application Priority Data
Oct. 20, 2000 (TW) 89218207

(51) Int. Cl. H01H 9/18

(52) U.S. Cl. 200/314

(57) ABSTRACT

A electrical switch that capable being combined with an electrical product. The electrical switch comprises a key cover that can combine with the outer surface of the electrical product, a spring and a light source. The inner surface of the key cover comprises a cylindrical protuberant structure at the both side of the inner surface. The key cover further comprises a cylindrical protrusion and a pair of hooks. The holes on the outer surface of the electrical product are corresponding to the shapes and the positions of the cylindrical protuberant structures, the cylindrical protrusion and the hooks. The spring is fixed onto the cylindrical protrusion, wherein the cylindrical protuberant structures and hooks allow the key cover fit onto the outer surface of the electrical product. The spring also creates tension between the key cover and the electrical product. The light source is located between the key cover and the electrical product, wherein the light is dispersed from a tooth shape light panel.

### CROSS-REFERENCE TO RELATED APPLICATION

This application claims the priority benefit of Taiwan application serial no. 89218207, filed Oct. 20, 2000.

### BACKGROUND OF THE INVENTION

1. Field of Invention

The present invention relates to an electrical switch. More particularly, the present invention relates to a combination of a switch with an electrical product.

2. Description of the Related Art

A switch can combine with an outer surface of an electrical product. This combination consists of a key cover on an outer surface of an electrical product, a spring and a light source. There is a cylinder that protrudes from both sides of the inner surface of a key cover, and there is also a cylindrical object and a pair of hooks. The position of the outer cover and shape fit into the cylindrical protrusion, the cylindrical object and the hook. Tension between the covers of the button and the electrical product is caused by using a spring hooks on the cylinder. The spring will fit in between the inner surface of the button cover and the outer surface of the electrical product. The light source is located in between the cover of the button and the electrical product, so it is dispersed from a tooth shaped light panel. Recently in the electrical products' market, particularly in communication and vision technology, the most popular type of electrical product is the electrical switch. A pressing key button switch and a pressing round button switch are popular traditional switch designs. However these switches are often individual products. In order to avoid damaging the appearance of the whole product a switch design must be limited to its size and visible surface location on a product. Therefore most of switches are specific to certain electrical applications or its limited locations.

FIG. 1 to FIG. 3 are three different design of electrical switches. FIG. 1 shows a popularly used switch with pressing button, design, it normally fits into the surface or the back of the electrical product. One side of the key button has a design for dispersing light, and only a limited amount of light is allowed to disperse out. Please refer to FIG. 2, showing a pressing round bottom switch that is usually more suitable for the visible surface of some products. FIG. 3 shows a switch combining the designs of FIG. 1 and FIG. 2.

As shown in the above-mentioned switches, a traditional switch will expose LED light around the switch or from a surface of the switch. Some products will disperse light from a light tube. Some will use only one layer to cover LED light. All these methods of dispersing light have a common disadvantage of directly exposing LED light, thereby allowing the light source to show only a small portion. However there is only one layer that covers LED light or dispersing light from a light tube, so a common problem is insufficient light and limited dispersing area.

The limitation of a switch design is due to the fact that it is an individual product and its size and location depend upon the electrical products and its position. Most switches are small and inconvenient for users to locate the correct positions. Light provided from a switch is very important due to its limited size. The visibility of a traditional switch is poor because the light is dispersed from direct exposure or through a light tube.

### SUMMARY OF THE INVENTION

Therefore, it is an object of the invention to provide an improved surface area of said switch compared to traditional switches. It is not only convenient for users to locate the switch but it also provides a pleasant and complete appearance.

It is a further object to provide improved visibility by a switch. The light source is connected in between a button and an electrical product and it is dispersed through a tooth shaped light panel. This method can prevent the light from directly dispersing and provide even lighting.

In order to achieve the purpose of this invention, an improved method of combining outer surfaces of a switch and an electrical product is provided. The invention combines the covers of a button a switch and an electrical product using a spring. There is a cylindrical protrusion on both sides of the inner surface of the button, and there is also a cylindrical object and a pair of hooks. An electrical product will fit into the cylindrical protrusion, cylindrical objects and holes of the hooks. In order to have a certain tension between the button and the outer layer of the electrical product; a spring is fit into the cylindrical object. By using the cylindrical protrusion and the hook, the whole switch is then fit onto an outer surface of an electrical product.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 to FIG. 3 are drawings of different electrical switch designs;

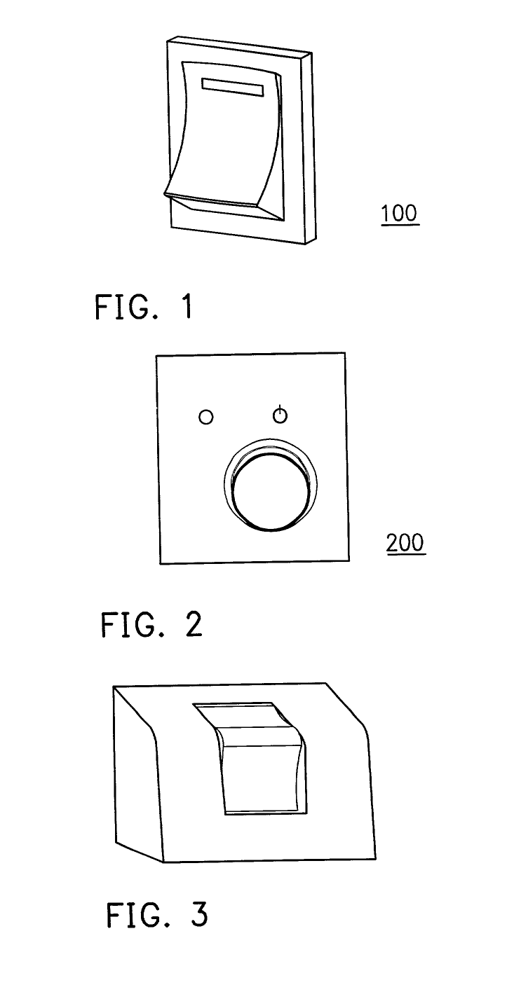

FIG. 4 is an actual drawing of the inside and outside of an electrical switch according to one preferred embodiment of this invention.

FIG. 5 is an assembled view of the electrical switch according to one preferred embodiment of this invention.

### DESCRIPTION OF THE PREFERRED EMBODIMENTS

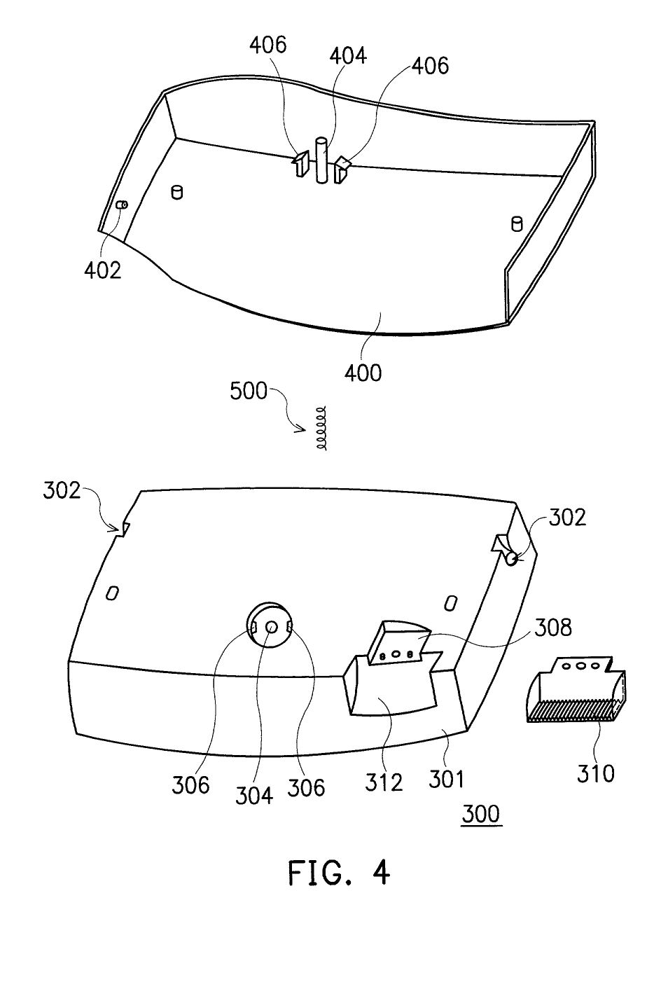

With references to FIG. 4, the drawing shows a combination of a switch structure and an outer surface of an electrical product.

A switch is combined with the outer surfaces of electrical product 300 and 301. The invention also has a pressing button 400 and a spring 500. There is a protuberant structure 402 has a cylindrical shape. The switch also has cylindrical object 404 and a pair of hooks 406. The invention provides a suitable location and size for the cylindrical protrusion 402, the cylindrical object 404, the pair of hooks 406 and holes 302, 304 and 306.

The inner surface of key cover 400 has a protuberant structure 402, cylindrical object 404 and a pair of hooks 406. The main reason for using a key cover 400 is to secure the outer surface 300 and 301 of the electrical product. Therefore the protuberant structure 402, cylindrical object 404 and the pair of hooks 406 which are on the inner surface of the key cover 400 can be replaced by other objects with the same function.

With reference to FIG. 4, because the protuberant structure 402 is on both sides of the key cover 400 on its both side and can fit perfectly into the holes 302, the key cover 400 will be fixed onto the outer surface 301 of the electrical product 300.

Once the whole key cover 400 is fixed onto the outer surface 301 of the electrical product 300, because the protuberant structure 402 on both sides, the position of the whole key cover can be adjusted by using the protuberant structure 402 as a center point.

The spring 500 is hooked in between the cylindrical object 404 and the hole 306 of the outer surface 301 of the electrical product 300.

Because the 406 is fit into the hole 306 of the electrical product 300, the key cover 400 can be fixed onto the outer surface 301 of the electrical product 300. By using the tension of the spring 500 which is hooked onto the cylindrical object 404 in between the key cover 400 and the outer surface 301 of the electrical product 300, the key cover has a pressing function. The hook can prevent the key cover 400 from rebounding.

With reference to FIG. 4, a switch combined with the outer surface of an electrical product is provided. A spring 500 hooks onto a cylindrical object 404 to create tension between the key cover 400 and an outer surface 301of an electrical product 300. Under this tension, the cylindrical object 404 of the inner surface of the key cover 400 will not contact the entire electrical switch that is underneath the hole 304 (not shown in the figure). When pressing the key cover 400, the cylindrical object 404 will come in contact with the whole electrical switch, which is situated below the hole 304 (not shown on the drawing).

Therefore the purpose of the cylindrical object 404 is to act as a trigger to open or close the switch.

After pressing the button, the spring 500 on the cylinder object 404 will rebound the key cover 400. The key cover 400 will come back to its original position because of the connection between the hook 406 and the hole 306. Therefore during the pressing process, the hook will prevent the key cover 400 from rebounding.

With reference to FIG. 4, there is a proper position for dispersing light from the outer surface 301 of the electrical product 300. For example, the lightness of LED can be determined from the position 312 of dispersing light which is dispersed from a tooth shaped light panel 310 that can be fit onto the outer surface 301 of the electrical product 300. The design of this invention is different from a conventional directly dispersing design. The dispersed light comes from the position 312 of dispersing light, which is dispersed from the light panel 310, wherein the dispersed light is more even and has a better visibility effect. The invention can combine with an electrical product to provide a switch with a bigger area, wherein the bigger area allows more light dispersed out to increase a visibility in a dark area and improved the outlook effect of the switch.

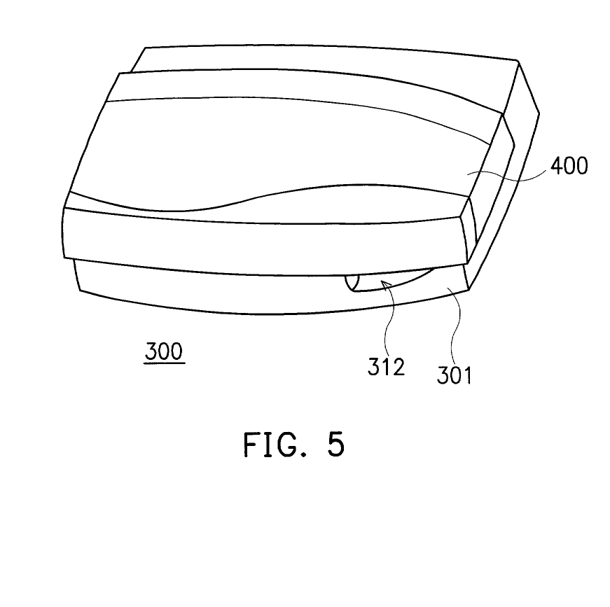

With reference to FIG. 5, the diagram illustrates an electrical switch combined with an electrical product of a preferred embodiment of the present invention. The whole structure of the switch, the only part that is exposed is the light source position 312 after the key cover 400 is fixed onto the outer surface 301 of the electrical product 300. The lightness of LED light is underneath the light position 308 (not show in the diagram) that is located between the key cover 400 and the electrical product 300.

FIG. 5 illustrates the key cover 400 has a bigger visible surface area due to the key cover 400 is combined with the outer surface 301 of the electrical product. Since the key cover has a bigger dispersing light area, it also has a better visibility effect, the user can easily locate the position of the switch without wasting time of finding the switch. The switch is easy to operate by pressing the key cover to switch on the electricity. The design of the switch with a larger surface area is a protection design to delay of switching off the electricity. The key cover has to be pressed down for 3 to 5 minutes in order to switch off the electricity. The purpose of this invention design is to protect the abnormal switch off electricity by miss pressing the button.

Otherwise, there are different types of light indications. For example there is one type when the switch is closed, the indication of light source is also off but when the switch is on, the indicated light is on at the same time. Another type is the colors of light source will change according to the status of the switch. For example, the color of the light can be green to indicate the switch is on and the color of the light can be red or other colors to indicate the switch is off. Therefore users can use the color of the light source to determine the switch is on or off and light source also can indicate the position of the switch.

From above-mentioned, this invention has several advantages as follow:

1. The invention is combined the key cover of the switch and the outer surface of an electricity product; therefore the key cover has a good visibility due to its large surface area and it also prevents the users spend excess time to locate the switch.

2. Due to a larger area of the key cover, there is a prevention of switch off rapidly design. In order to switch off the electricity the key cover has to be pressed down for several seconds, this is to prevent the suddenly cut off electricity situation when users miss press the key cover.

3. Due to its larger surface area of the key cover and proper spring location, users can switch on electricity easily from the switch of an electricity product.

4. Due to its combination design between the key cover and outer surface of the electricity product, the whole product has a better appearance. The light also dispersing from the light panel not dispersing directly, therefore the light source shows a larger area effect and a better appearance.

5. By using different color of the light source to indicate the status of the switch and the light can used as guide light in the dark to located the position of the switch.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrical switch, capable of being combined with an electrical product, the switch comprising.
a key cover, having an inner surface of the key cover fixed into an outer surface of the electrical product, wherein the inner surface of the key cover having a cylindrical object, a pair of hooks and at least two cylindrical protrusions, wherein profiles and locations of a plurality of holes on the outer surface of the electrical product are corresponding to the cylindrical object, the hooks and the cylindrical protrusions, wherein an ON/OFF status of the electrical product is controlled by the cylindrical object; and
a spring, hooked onto the cylindrical object, for allowing the key cover being combined with an outer surface of the electrical product by using the hooks and the cylindrical object.

2. The switch of claim 1, wherein said the protuberant structure is cylindrical.

3. The switch of claim 1, further comprising a light source, wherein the light source comprises
a LED light; and
a light panel that disperses light from the LED light.

4. The switch of claim 1 wherein the spring creates tension between the key cover and the electrical product.

5. The switch of claim 1 wherein the holes comprises two circular holes that are corresponding to the cylindrical protrusions, which are on the both sides of the outer surface of the electrical product, in order to allow the key cover to fix onto the outer surface of the electrical product.

6. The switch of claim 1 wherein the holes further comprise a round hole that is corresponding to the cylindrical protrusion.

7. The switch of claim 1 wherein the holes comprise two pair holes that are corresponding to the hooks in order to secure the hooks.

8. An electrical switch, capable of being combined with an electrical product, the switch comprising:
a key cover, having an inner surface that fixed into an outer surface of the electrical product; and
a spring, maintaining tension between the key cover and the electrical.

9. The switch of claim 8, wherein the key cover comprises:
a cylindrical protrusion, locating between the spring and the outer surface of the electrical product in order to control a ON/OFF status of the electrical switch;
a pair of hooks, preventing the key cover from rebounding; and
two protrusions, locating on the both sides of the inner surface of the key cover, wherein the key cover is fixed onto the electrical product.

10. The switch of claim 9, wherein the two protrusions are cylindrical protuberant structures.

11. The switch of claim 9, wherein the outer surface of the electrical switch comprises a plurality of holes that are corresponding to shapes and locations of the cylindrical protrusions, the hooks and the cylindrical protuberant structures.

12. An electrical switch, capable of being combined an electrical product, wherein an outer structure of the electrical product comprises:
a key cover, coving the outer surface of the electrical product, wherein an inner surface of the key cover that is corresponding to the outer surface of the product comprises
a cylindrical protrusion, a pair of hooks and two protuberant structures, which are located at the sides of the inner surface of the key cover to control the ON/OFF status of the electrical product; and
a spring, maintaining tension between the outer surface of the product and the key cover.

13. The switch of claim 12, wherein the protuberant structures are cylindrical protuberant structures.

14. The switch of claim 12, wherein the outer surface of the electrical product comprises two pair of holes that are corresponding to the protuberant structures that are located at the sidewall of the inner surface of the key cover in order to fit the key cover onto the electrical product.

15. The switch of claim 12, wherein the outer surface of the electrical product comprises a round hole that is corresponding to the cylindrical protrusion.

16. The switch of claim 15, wherein the cylindrical protrusion fits through the spring into the round hole so that when the key cover is pressed down, the cylindrical protrusion will come into contact with the electrical product and it will then trigger the ON/OFF switch of the electrical product.

17. The claim 12 wherein the electrical product comprises two pair of holes are corresponding to the hooks in order to secure the hooks.

18. The switch of claim 12, wherein the switch comprises a light source, the light source further comprises
a LED light; and
a light panel that disperses light from the LED light.
